(19) United States
(12) Patent Application Publication
(10) Pub. No.: US 2011/0061260 A1
(43) Pub. Date: Mar. 17, 2011

(54) Apparatus for drying structural cavities

(76) Inventor: Thomas D. Geer, Bozeman, MT (US)

(21) Appl. No.: 12/807,362

(22) Filed: Sep. 2, 2010

Related U.S. Application Data
(60) Provisional application No. 61/275,872, filed on Sep. 3, 2009.

(51) Int. Cl. F26B 21/00; F26B 25/12

(52) U.S. Cl. 34/218

(57) ABSTRACT

Apparatus for drying structural cavities located within a space defined by a floor and a vertical surface such as a wall or cabinet includes an elongate sheet of flexible material and a plurality of spaced apart and parallel arranged reinforcing bars extending in a lateral direction between the longitudinal ends of the elongate sheet. The elongate sheet with the reinforcing bars is positioned to diagonally span across the cavity and an air blower is provided for blowing air into the cavity.

This application claims the benefit of provisional application Ser. No. 61/275,872 filed Sep. 3, 2009.

### BACKGROUND OF INVENTION

The present invention relates to apparatus for drying structural cavities. For example, the apparatus may be used to dry a sill plate underneath an existing wall. This apparatus may also be used to dry underneath cabinets such as kitchen cabinets resting on a floor and can also be used for drying a sill plate of a stud wall before sheetrock has been installed.

### SUMMARY OF INVENTION

The present invention is directed to apparatus for drying structural cavities located within a space defined by a floor and a vertical surface such as a wall or cabinet. The apparatus includes an elongate sheet of flexible material and a plurality of spaced apart and parallel arranged reinforcing bars extending in a lateral direction between the longitudinal ends of the elongate sheet. The elongate sheet with the reinforcing bars is positioned to diagonally span across the cavity and an air blower is provided for blowing air into the cavity.

### BRIEF DESCRIPTION OF THE DRAWINGS

In order that the invention may be clearly understood and readily carried into effect, a preferred embodiment of the invention will now be described, by way of example only, with reference to the accompanying drawings wherein:

FIG. 1 is a front plan view of apparatus according to the present invention;

FIG. 2 is a rear plan view of the apparatus shown in FIG. 1;

FIG. 3 is a partial plan view of the apparatus shown in FIG. 1;

FIG. 4 is a partial plan view of the apparatus shown in FIG. 2;

FIG. 5 is a perspective view of the apparatus used to dry a sill plate under an existing wall;

FIG. 6 is a perspective view of the apparatus used to dry underneath wall mounted cabinets; and

FIG. 7 is a perspective view of the apparatus used for drying a sill underneath a stud wall.

### DESCRIPTION OF A PREFERRED EMBODIMENT

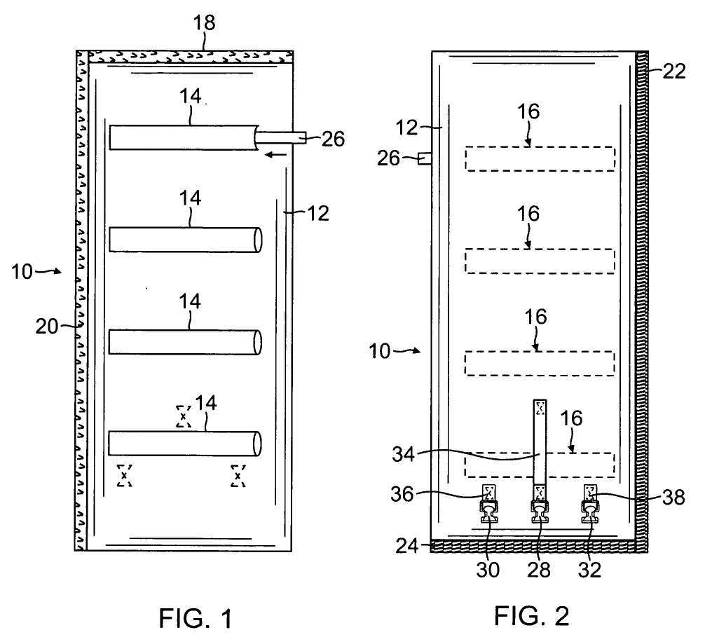

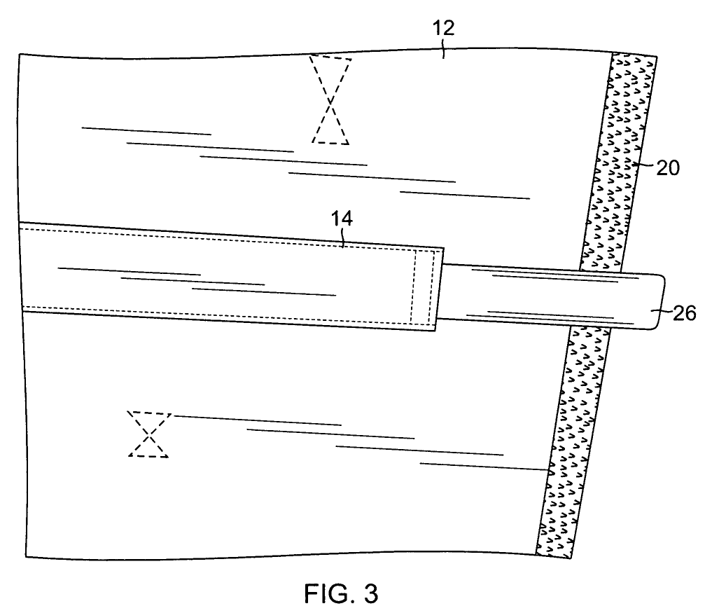

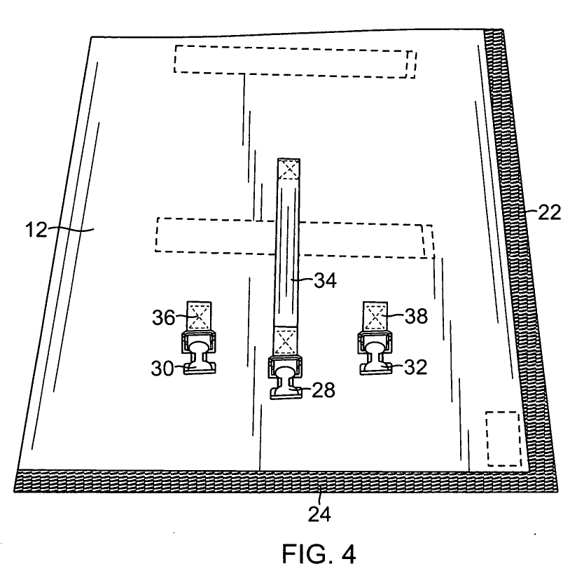

The apparatus 10, according to the present invention, is shown in FIGS. 1 and 2. The apparatus 10 includes a sheet of vinyl material 12. However other sheets of material such as plastic or canvas could be used equally as well. A series of spaced apart and parallel arranged pockets 14 are sewn on to the vinyl sheet 12 at 16 as shown in FIG. 2. An end lateral edge of sheet 12 is provided with a Velcro® type hook material 18 and the longitudinal edge of the sheet 12 is provided with a Velcro® type hook material 20. On the opposite side of the sheet 12 and along the same longitudinal edge is provided a Velcro® type loop material 22 as shown in FIG. 2. At an end lateral edge opposite from the Velcro® type material 18 and on the opposite side of the sheet 12 is provided a Velcro® type loop material 24 as shown in FIG. 2.

A rigid bar 26 is inserted in each of the pockets 14 as shown in FIG. 1. The rigid bar 26 in a preferred embodiment has weight to provide rigidity and stability to the sheet 12 when it is being used. Three clips 28, 30 and 32 are connected with straps 34, 36, and 38 respectively which are in turn sewn to the sheet 12 as shown in FIGS. 2 and 4.

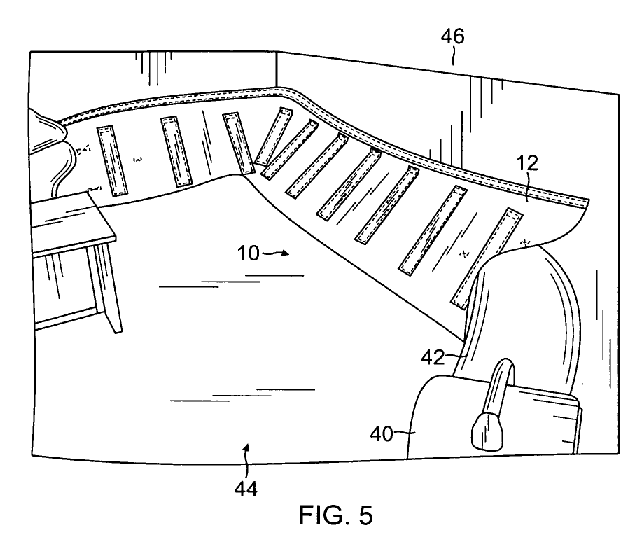

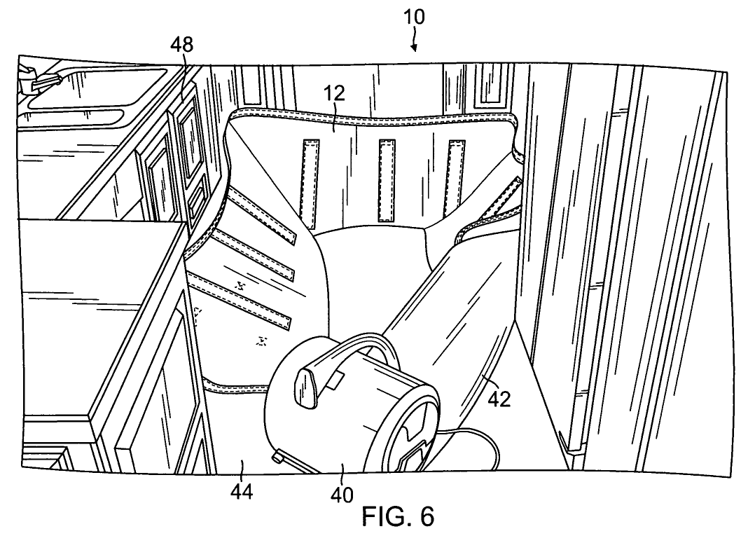

When using the invention, the apparatus 10 is used with an air mover 40 as shown in FIG. 5 which blows air into a lay flat ducting tube 42. The end of the lay flat ducting tube 42 is clipped with the clips 28, 30 and 32, shown in FIG. 2. The strap 34 is longer than the other two straps 36 and 38 and is used for clipping to the bottom of the lay flat ducting tube 42.

As shown in FIG. 5, the apparatus 10 can be used for drying underneath a sill plate of a wall by placing the sheet 12 diagonally across the junction between a floor 44 and the wall 46 as shown in FIG. 5. The rigid bars 26 are placed diagonally between the floor 44 and the wall 46 and serve to provide rigidity to the sheet 12 and also act as a weight to hold the sheet 12 against the floor 44 and the wall 46.

Similarly the apparatus 10 can be used to dry underneath cabinets as shown in FIG. 6. When apparatus 10 is being used in this manner, the sheet 12 is placed diagonally across the junction between the floor 44 and cabinets 48 with the rigid bars 26 correspondingly placed diagonally between the floor 44 and the cabinets 48. When the air mover 40 is actuated, air is transported through the lay flat ducting 42 to the space between the vinyl sheet 12 and the cabinets 48.

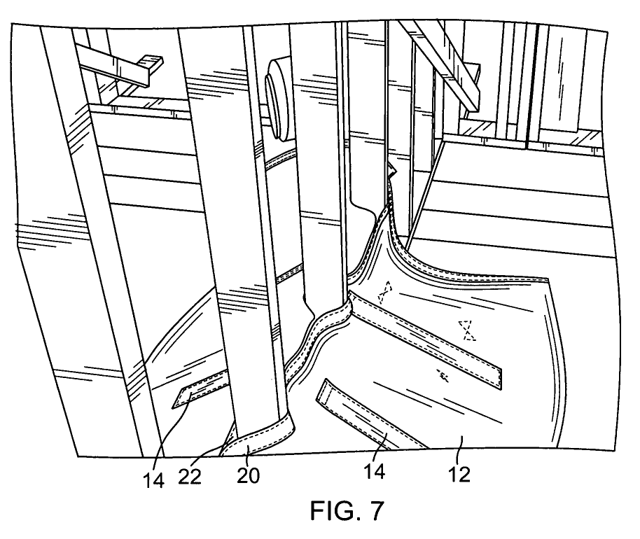

The apparatus 10 can also be used when drying a sill plate under a stud wall before the sheet rock is applied. In using the apparatus 10 for this purpose, two sheets 12 are joined together with a Velcro® type hook material 20 of one sheet and the Velcro® type loop material 22 of an adjacent sheet as shown in FIG. 7.

Further, when additional length of the sheets are needed, adjoining sheets can be joined together using the Velcro® type hook material 18 of one sheet joined together with the Velcro® type loop material 24 of an adjacent sheet.

With the present invention, apparatus is provided for drying several types of structural cavities. The apparatus is versatile, easy to make, and easy to use.

While the fundamental novel features of the invention have been shown and described, it should be understood that various substitutions, modifications, and variations may be made by those skilled in the arts, without departing from the spirit or scope of the invention. Accordingly, all such modifications or variations are included in the scope of the invention as defined by the following claims:

I claim:

1. Apparatus for drying structural cavities located within a space defined by a floor and a vertical surface such as a wall or cabinet comprising:
an elongate sheet of flexible material having a first and second opposed longitudinal edges and a first and second opposed lateral end edges;
a plurality of spaced apart and parallel arranged reinforcing bars secured to the elongate sheet and extending in a lateral direction between the first and second opposed lateral end edges;
the elongate sheet with reinforcing bars positioned to diagonally span across the cavity between the floor and vertical surface; and
an air blower for blowing air into the cavity;

2. The apparatus according to claim 1 wherein the flexible material comprises a vinyl material.

3. The apparatus according to claim 1 further including a plurality of spaced apart and parallel arranged pockets for receiving the reinforcing bars.

4. The apparatus according to claim 1 further including a strip of hook fastening material secured to the elongate sheet adjacent the first lateral end edge of the elongate sheet on a front face thereof and a strip of loop fastening material secured to the elongate sheet adjacent the second lateral end edge of the elongate sheet on a rear face thereof wherein a pair of elongate sheets can be joined end to end by meshing the strip of hook fastening material of an elongate sheet with the strip of loop fastening material of the adjoining elongate sheet.

5. The apparatus according to claim 1 further including a strip of hook fastening material secured to the elongate sheet adjacent the first longitudinal edge of the elongate sheet on a front face thereof and a strip of loop fastening material secured to the elongate sheet adjacent the first longitudinal edge of the elongate sheet on a rear face thereof wherein a pair of elongate sheets can be joined side to side by meshing the strip hook fastening material of one elongate sheet with the strip of loop fastening material of the adjoining elongate sheet.
